(19) United States
(12) Patent Application Publication
(10) Pub. No.: US 2016/0306416 A1
(43) Pub. Date: Oct. 20, 2016

(54) Apparatus and Method for Adjusting Processor Power Usage Based On Network Load

(71) Applicant: Intel Corporation, Santa Clara, CA (US)

(72) Inventors: John Browne, Limerick (IE); Chris Macnamara, Limerick (IE)

(21) Appl. No.: 14/688,019

(22) Filed: Apr. 16, 2015

(51) Int. Cl. G06F 1/32

(52) U.S. Cl. CPC G06F 1/3296; G06F 1/3228

(57) ABSTRACT

In an embodiment, a system includes a processor that includes a plurality of cores and a plurality of queue. Each queue includes storage locations to store packets to be processed by at least one of the cores. Each queue has a corresponding state that is one of active and inactive. Each active queue is enabled to store an incoming packet, and each inactive queue is disabled from storage of the incoming packet. Each queue has a corresponding queue depth that includes a count of occupied storage locations of the queue. The system also includes packet distribution logic to determine whether to change the state of a first queue of the plurality of queues from a first state to a second state based on a total queue depth that includes a sum of the queue depths of the active queues. Other embodiments are described and claimed.

### TECHNICAL FIELD

Embodiments relate to power management of a system, and more particularly to power management of a multicore processor.

### BACKGROUND

Advances in semiconductor processing and logic design have permitted an increase in the amount of logic that may be present on integrated circuit devices. As a result, computer system configurations have evolved from a single or multiple integrated circuits in a system to multiple hardware threads, multiple cores, multiple devices, and/or complete systems on individual integrated circuits. Additionally, as the density of integrated circuits has grown, the power requirements for computing systems (from embedded systems to servers) have also escalated. Furthermore, software inefficiencies, and its requirements of hardware, have also caused an increase in computing device energy consumption. In fact, some studies indicate that computing devices consume a sizeable percentage of the entire electricity supply for a country, such as the United States of America. As a result, there is a vital need for energy efficiency and conservation associated with integrated circuits. These needs will increase as servers, desktop computers, notebooks, Ultrabooks™, tablets, mobile phones, processors, embedded systems, etc. become even more prevalent (from inclusion in the typical computer, automobiles, and televisions to biotechnology).

### BRIEF DESCRIPTION OF THE DRAWINGS

FIG. 1 is a block diagram of a system, according to an embodiment of the present invention.

FIG. 2 is a block diagram of a system, according to another embodiment of the present invention.

FIG. 3 is a block diagram of a system, according to an embodiment of the present invention.

FIG. 4 is a flow diagram of a method, according to an embodiment of the present invention.

FIG. 5 is a flow diagram of a method, according to another embodiment of the present invention.

FIG. 6 is a flow diagram of a method, according to another embodiment of the present invention.

FIG. 7 is a block diagram of a system, according to another embodiment of the present invention.

FIG. 8 is a block diagram of a system, according to another embodiment of the present invention.

### DETAILED DESCRIPTION

In order to conserve power in a system that includes a multi-core processor, some multi-core processors permit one or more cores to be placed in a low power state (e.g., reduced clock frequency, reduced operating voltage, or one of several sleep states, in which some or all core circuitry of a core is turned off). For example, to save energy during periods of low activity, a core may be placed in a sleep state, e.g., one of states C₁ to C_{N} that consumes less power than when the core is in an active state (C₀), according to an Advanced Configuration and Power Interface (ACPI) standard, e.g., Rev. 5.1, published April, 2014. Alternatively, one or more cores may be placed in a low power-performance state, e.g., one of states P₁ to P_{N}, in which a clock frequency and/or operating voltage may be reduced in comparison with clock frequency and/or operating voltage of a core in the active state (P₀), according to the Advanced Configuration and Power Interface (ACPI) standard, e.g., Rev. 5.1, published April, 2014.

A computer system may be coupled to a network from which the computer system may receive data packets. The computer system may include a multi-core processor that is to process incoming data packets received via the network.

Random distribution of the incoming data packets to the cores of the processor to be processed may result in power usage inefficiencies in the processor. In embodiments, a mechanism may be employed to steer received network traffic, e.g., data packets (also packets herein) received from the network, to be processed in active cores and permitting inactive (e.g., deactivated) cores to remain inactive, e.g., in a sleep state or in a reduced power state. The mechanism may wake a sleeping core when a load threshold is reached. Based on load conditions, cores can be transitioned from a high power state to low power state, or from a low power state to a high power state. A power saving goal may be to have a largest number of cores remain in a sleep state while the active cores of the processor process the received network traffic, which goal may be realized via embodiments presented herein.

In embodiments, a network interface card (NIC) and the processor can work together to achieve power savings by minimizing a count of active cores utilized to process packets that are received from the network via the NIC. The NIC may deactivate (or activate) one or more queue buffers (also “queues” herein), each queue corresponding to a core to which packets are to be delivered. Minimization of a count of active queues that feed packets to active cores may allow for a largest number of the cores to be placed into (or to remain in) a low power state e.g., a sleep state or in a reduced power/performance state, e.g., operational at a clock frequency that is reduced from its normal clock frequency, or at a reduced voltage.

In embodiments, based on load conditions, a core can be transitioned from a high power use state to a low power use state associated with deactivation of a corresponding queue, or from low power use state to a high power use state associated with activation of the corresponding queue.

In an embodiment, a mechanism may consolidate processing of received traffic into fewer than all available cores. For example, for a processor with three cores each of which is operating at 10% capacity, a workload may be redistributed to one core that runs at 30% capacity. The remaining two cores may be placed into a power saving state (e.g., C(1)-C(N), etc.), from which one or both cores can be reactivated when additional received traffic warrants additional processing power. The mechanism can be implemented by the NIC providing a queue scheduling function that minimizes the count of active queues.

As an example, the mechanism may be implemented according to pseudo-code, as follows (here queue depth (i) is a measure of occupancy of storage locations within an i^{th} queue, where each storage location can store a packet):

If sum of queue depths (i)>a first threshold (e.g., 75% depth), activate one or more queues from a pool of inactive queues

Else if sum of queue depth<second threshold (e.g., 25% depth) deactivate one or more queues (and do not send additional incoming packets to the queue to be deactivated)

Else Continue

In embodiments, a configurable action for C states or P states may be implemented as an interrupt from the NIC to a core. When a queue threshold (e.g., the first threshold in the pseudocode above) is exceeded and a corresponding queue is activated, the core may be woken up by the NIC.

In embodiments, a “one shot” interrupt may be programmed by a host. The one shot interrupt may be triggered by the NIC to wake a core in a sleep mode that is to be fed packets by a queue to be activated.

In other embodiments, software running on the processor may detect a presence of a packet that has been stored in a newly activated queue, and may cause the corresponding core to be re-activated from a sleep state or low power/performance state in order to process the stored packet.

In embodiments, one or more cores may operate in fully active mode, e.g., at high clock frequency and full operating voltage, while other cores may remain in operation at a low frequency and/or reduced voltage. In embodiments, traffic may be directed to one or more cores that operate at the high clock frequency (and full operating voltage), while other cores can be idle in a low power state. In some embodiments the thresholds can be dynamic, e.g., determined as a function of other parameters such as a rate of change of queue depths, e.g., a rate of change over time of the sum of queue depths (total queue depth herein). Reduction of a count of active cores can result in power savings.

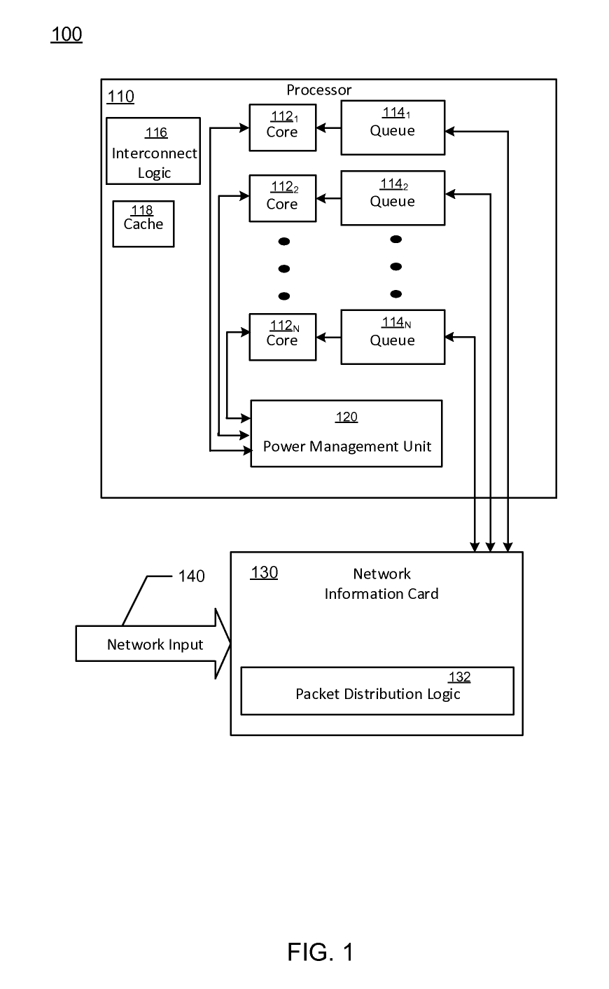

FIG. 1 is a block diagram of an apparatus, according to an embodiment of the present invention. Apparatus 100 includes a processor 110 and a network information card (NIC) 130 coupled to the processor 110. The processor 110 includes cores 112₁-112_{N}, queues 114₁-114_{N}, interconnect logic 116, cache memory 118, power management unit 120, and may include other components. The NIC 130 includes packet distribution logic 132.

In operation, the NIC 130 may receive network input 140, e.g., incoming data packets from a network (not shown) to which the NIC 130 is coupled. The packet distribution logic 132 may determine whether to increase (or to decrease) a count of active queues from the queues 114 based on each queue's occupancy, e.g., portion of the queue that is occupied with packets to be processed by the corresponding core. The packet distribution logic 132 may determine which queue is to receive each of the incoming packets, and the NIC 130 may steer each incoming packet to a corresponding destination queue 114ᵢ.

For each received incoming packet the corresponding destination queue 114, may be determined based on queue depth (e.g., occupancy) of each active queue. For example, the NIC 130 may steer each packet to a corresponding queue that has a lowest queue depth (e.g., least occupancy) of the active queues.

In an embodiment, the packet distribution logic 132 may determine that a total queue depth of all active queues exceeds a first threshold (e.g., a total occupancy exceeds the first threshold), and the packet distribution logic 132 may select an inactive queue to be activated in order to handle incoming traffic (e.g., incoming packets). Activation of a particular queue may be accompanied by activation of the corresponding core, e.g., from a lower power state (e.g., a sleep state e.g., one of sleep states C₁-C_{N}, or a low power/performance state, e.g., one of low power/performance states P₁-P_{N}) to an active state.

Upon activation of the particular queue, additional incoming packets can be placed in the particular queue, to be processed by the corresponding core after activation of the corresponding core. In one embodiment, the NIC 130 distributes the received packets and the active queue with the lowest occupancy (e.g., storing the least number of packets) is to receive a next incoming packet.

The packet distribution logic 132 may monitor occupancy of the active queues, and if the total occupancy (e.g., total queue depth) of all active queues falls below a second threshold, the packet distribution logic 132 may deactivate a selected queue that is active. After any remaining packets in the selected queue(s) are processed, the corresponding core(s) may be placed into a low power state, e.g., C₁-C_{N} or P₁-P_{N}.

Thus, the packet distribution logic 132 may monitor each of the queues 114 to determine if there is high occupancy (high total queue depth) or a low occupancy (low total queue depth). If a total occupancy is low, the packet distribution logic 132 may deactivate one or more of the queues 114, and after any remaining packets in the deactivated queue(s) are processed, the corresponding core(s) may be placed into a lower power state. Alternatively, software running in the processor 110 may cause the corresponding core to be placed into a lower power state responsive to detecting that the corresponding queue is vacant.

In an embodiment, the PMU 120 may monitor activity level of each core 112i and may detect that a particular core corresponding to the deactivated queue is idle, which may indicate to the PMU 120 to power down the particular core. Any queue that has been deactivated may continue to feed packets to its corresponding core until the deactivated queue is empty. When the deactivated queue is empty, the corresponding core may be placed in a low power consumption state, e.g., one of sleep states C₁-C_{N} or reduced power states P₁-P_{N}. No additional packets will be supplied to a deactivated queue. Placement of a core into a low power consumption state or reduced power consumption state may lower an overall energy consumption of the processor 110.

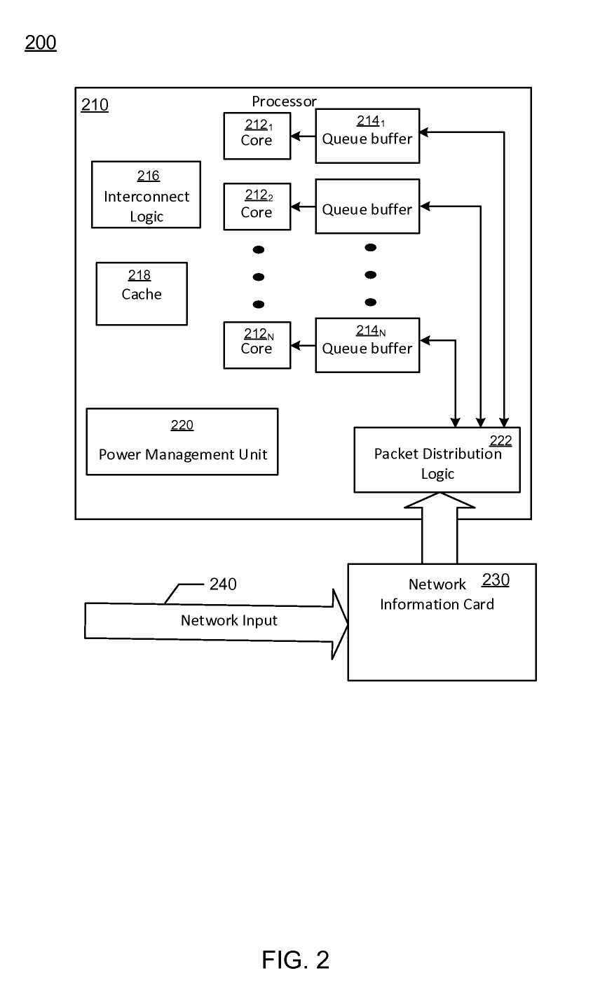

FIG. 2 is a block diagram of a system, according to another embodiment of the present invention. System 200 includes a processor 210 and a network information card (NIC) 230 coupled to the processor 210. The processor 210 includes cores 212₁-212_{N}, queues 214₁-214_{N}, interconnect logic 216, cache memory 218, power management unit 220, packet distribution logic 222, and may include other components.

In operation, the NIC 230 may receive network input 240, e.g., incoming data packets from a network (not shown) to which the NIC 230 is coupled. The NIC 230 may transmit the incoming data packets to the packet distribution logic 222. The packet distribution logic 222 may determine which queue is to receive each of the incoming packets, and may direct each incoming packet to a corresponding destination queue 214ᵢ.

For each received incoming packet the corresponding destination queue may be determined based on queue depth of each active queue. For example, the packet distribution logic 222 may direct each packet to the queue that has a least queue depth of the active queues.

The packet distribution logic 222 may determine which of the queues 214ᵢ are to be activated or deactivated, based on a sum of each queue's queue depth. In an embodiment, the packet distribution logic may determine that a total available capacity of all active queues exceeds a first threshold and may select a particular queue to activate to increase a count of active queues. Changing the particular queue to an active state may be accompanied by activation of a corresponding core from a lower power state, e.g., C₁-C_{N}, or P₁-P_{N}. In one embodiment, the packet distribution logic 222 may trigger a “one shot” interrupt to wake the corresponding core. Alternatively, software running in the processor may determine to power up the core based on a packet that is stored in the corresponding queue. Alternatively PMU 220 may monitor activity level of each core and may change operating parameters of the corresponding core (e.g., operating voltage and clock frequency) responsive to detection by the PMU 220 of increased traffic to a particular core.

As network input 240 continues (e.g., packets are received from the network), the packet distribution logic 222 is to distribute the received packets to the queues that are active. In one embodiment, the active queue with the least queue depth is to receive an incoming packet.

The packet distribution logic 222 may determine that the total queue depth of active queues is less than a second (e.g., low) threshold. The packet distribution logic 222 may determine that one of the active queues is to be deactivated. The particular queue selected for deactivation does not receive additional incoming packets from the packet distribution logic 222. Instead, the packets stored in the particular queue are to be processed by the corresponding core, and when the particular queue is vacant, the corresponding core can be placed into a lower power state, e.g., C₁-C_{N}, or P₁-P_{N}. No additional packets will be supplied to an inactive queue. Placement of a core into a low power consumption state or reduced power consumption state may result in lower overall energy consumption of the processor 210. The inactive queue and corresponding core may be reactivated at a future time in response to increased network traffic.

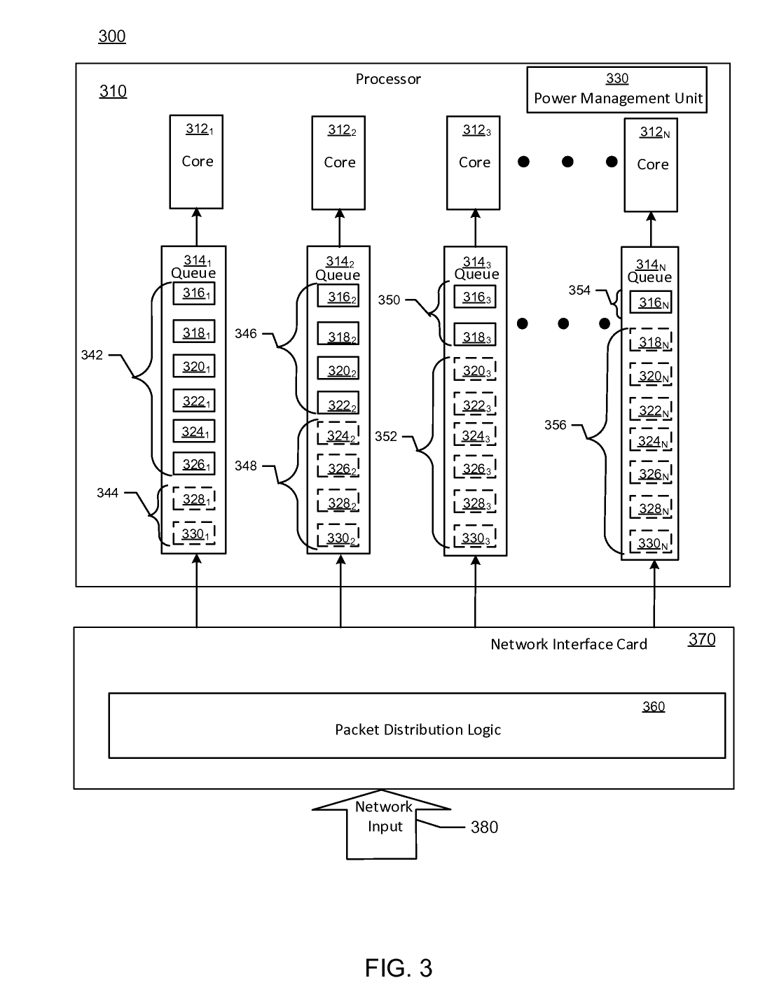

FIG. 3 is a block diagram of a system, according to another embodiment of the present invention. System 300 includes processor 310 and network interface card (NIC) 370.

In operation, the NIC 370 is to receive packets from a network via a network input 380. Packet distribution logic 360 (e.g., hardware, firmware, software, or a combination thereof) is to determine, for each packet received via network input 380, a queue 314, (e.g., one of 314₁-314_{N}) to which the packet is to be temporarily stored until a corresponding core 312ᵢ is ready to receive and process the packet. In the embodiment of FIG. 3, each queue 314ᵢ corresponds to a single core 312ᵢ. In other embodiments, a plurality of queues may feed a single core, or a single queue may feed a plurality of cores.

The packet distribution logic 360 may monitor each of the queues 314₁-314_{N} regarding occupancy. That is, as shown in FIG. 3, queue 314₁ includes an occupied region 342 that includes locations 316₁, 318₁, 320₁, 322₁, 324₁, and 326₁. Each of the locations 316₁-326₁ stores a packet that has been received from the NIC 370. The queue 314₁ includes an unoccupied region 344 that includes locations 328₁ and 330₁ that are vacant. Similarly, queue 314₂ includes an occupied region 346 that includes locations 316₂, 318₂, 320₂, and 322₂. Each of the locations 316₂, 318₂, 320₂, 322₂ stores a packet that has been received from the NIC 370. The queue 314₂ includes an unoccupied region 344 that includes locations, 324₂, 326₂, 328₂, and 330₂ that are vacant. Queue 314₃ includes occupied region 350 (e.g., occupied locations 316₃, 318₃) and unoccupied region 352 (e.g., 320₃-330₃). Queue 314_{N} includes occupied region 354 (e.g., occupied location 316_{N},) and unoccupied region 352 (e.g., 318_{N}-330_{N}).

The packet distribution logic 360 may determine a total queue depth (e.g., total occupancy) e.g., a count of all occupied storage locations within active queues, e.g., a count of all locations within 342, 346, 350, . . . 354. The packet distribution logic 360 may perform a comparison of the total queue depth to a first threshold (e.g., a high threshold). If the total queue depth is greater than the first threshold, the packet distribution logic 360 may determine to activate an additional queue from an inactive state, in order to increase storage availability for incoming packets. The packet distribution logic 360 may designate the additional queue as active, e.g., available to receive incoming packets.

The additional queue may feed an additional core (not shown) that is to be wakened (or raised in activity level) from a low power state. Thus, when additional execution capacity is warranted, a selected inactive queue can be activated to receive incoming packets and the corresponding inactive core that is in a sleep state or low power state can be fully activated or raised to a higher level of activity. In one embodiment, the corresponding core 312, can be awakened via a one-shot interrupt message from the packet distribution logic 360. In another embodiment, software that runs in the processor can monitor one or more memory locations, e.g., within the queue that is activated from its inactive state, and when a packet arrives in the activated queue the software can cause the corresponding core to become activated so as to process the packet that has arrived in the activated queue.

The packet distribution logic 360 may perform a comparison of the total queue depth to a second threshold, e.g., a low threshold. If the total queue depth is less than the second threshold the packet distribution logic 360 may determine to deactivate a selected queue that is in an active state, e.g., queue 314₃. When the queue 314₃ is deactivated by the packet distribution logic 360, no additional incoming packets will be stored in queue 314₃. Packets that are stored in queue 314₃ (e.g., in locations 316₃ and 318₃) will be processed by core 312₃, and when queue 314₃ is vacant, core 312₃ can be placed into a sleep state (or a low power state), e.g., by a power management unit (PMU) 330. In some embodiments, the PMU 330 can closely monitor an activity level of the corresponding core, and after the packets stored in the particular core have been processed and the core becomes idle, the PMU 330 can place the core into a sleep state (e.g., C₁-C_{N}) or into a reduced power/performance state (e.g., P₁-P_{N}). Reduction in the number of active queues can enable a reduction in the number of active cores, which can reduce an overall energy consumption of the processor 310.

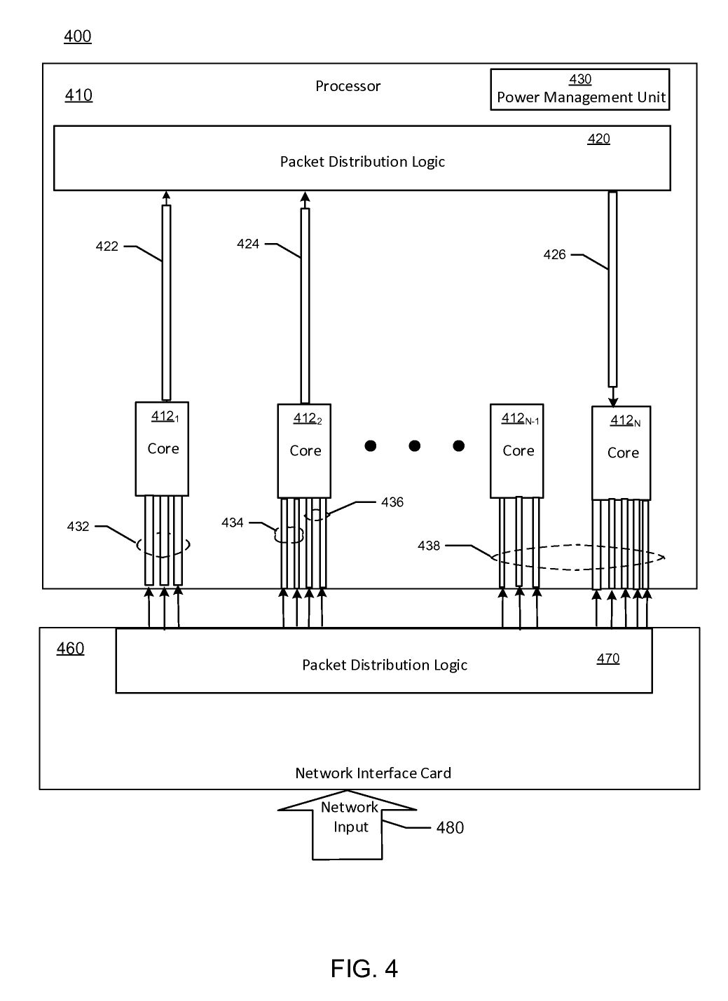

FIG. 4 is a block diagram of a system, according to another embodiment of the present invention. System 400 includes a processor 410 and a network interface card (NIC) 460 coupled to the processor, and may include other components, e.g., dynamic random access memory, etc. (not shown). The processor 410 includes a plurality of cores 412₁-412_{N}, packet distribution logic 420 (e.g. hardware, firmware, software, or a combination thereof), a power management unit (PMU) 430, a plurality of queues including queue bundles 422, 424, 426, 432, 434, 436, and 438, and may include other components (not shown) such as cache memory, interconnect logic, etc. The NIC 480 includes packet distribution logic 470 (e.g. hardware, firmware, software, or a combination thereof).

In operation, the NIC 460 may receive packets from a network via a network input 480. Packet distribution logic 470 is to determine, for each packet received via network input 480, a particular queue within a queue bundle (e.g., a set of one or more queues) to temporarily store the packet until a corresponding core 412, (an i^{th} core of cores 412₁-412_{N}) is ready to receive and process the packet. In the embodiment of FIG. 4, queue bundle 432 is to feed packets into core 412₁, queue bundles 434 and 436 are to feed packets into core 412₂, and queue bundle 438 is to feed packets into cores 412_{N-1} and 412_{N}. In other embodiments, each queue bundle may feed packets into one or more cores.

The packet distribution logic 470 may monitor each of the queue bundles 432, 434, 436, . . . 438 regarding available storage capacity. The packet distribution logic 470 may determine a total queue depth (e.g., a count of all occupied locations within 432, 434, 436, . . . 438). The packet distribution logic 470 may perform a comparison of the total queue depth to a first threshold (e.g., high threshold). If the total queue depth is greater than the first threshold the packet distribution logic 470 may determine to activate an additional queue bundle from an inactive state in order to increase storage availability for incoming packets. The additional activated queue bundle may feed an additional core (not shown) after the core is awakened from a low power state.

The packet distribution logic 470 may designate the additional queue bundle as active, e.g., available to receive incoming packets. In an embodiment, the packet distribution logic 470 may send a “wakeup message” to the additional core. In another embodiment, software running on the processor 410 may detect that an incoming packet has been sent to the activated queue bundle and may wake a corresponding core (one of 412ᵢ) to process the incoming packet that is to be supplied by the activated queue bundle.

Thus, when additional execution capacity is warranted, an additional queue bundle can be activated to receive incoming packets, and one (or more) corresponding core(s) in a sleep state (or low power state), can be activated or raised from its low power state to a higher level of activity to receive packets from the additional activated queue bundle.

The packet distribution logic 470 may perform a comparison of the total queue depth to a second threshold, e.g., a low threshold. If the total queue depth is less than the second threshold the packet distribution logic 470 may determine to de-activate a selected queue bundle that is in an active state, e.g., queue bundle 432. When the queue bundle 432 is deactivated by the packet distribution logic 470, no additional incoming packets will be stored in queue bundle 432. Packets that are stored in queue bundle 432 will be processed by core 412₁, and when queue bundle 432 is vacant, core 412₁ can be placed into a sleep state (or a low power state), e.g., by PMU 430. Thus, reduction in the number of active queues can enable a reduction in the number of active cores, which can reduce overall energy consumption of the processor 410.

The PMU 430 can monitor an activity level of each core, and if a particular queue bundle is deactivated, after the packets stored in a corresponding core have been processed and the corresponding core becomes idle, the PMU 430 can place the corresponding core into a sleep state (e.g., C₁-C_{N}) or into a low power state (e.g., P₁-P_{N}) by, reduction of operating voltage, reduction of clock frequency, or a combination thereof. Alternatively, software that runs on the processor 410 can monitor occupancy of locations within a queue, and when the queue depth falls below a particular level, the software can direct the corresponding core to become inactive, e.g. a sleep state (e.g., C₁-C_{N}) or a low power state (e.g., P₁-P_{N}).

Packet distribution logic 420 within the processor 410 may re-distribute packets from a first core to a second core, e.g., in order to minimize a count of active queues and a count of active cores, which can result in a power savings. For example, packet distribution logic 420 may accept selected packets via queues 422 and 424 (e.g., packets to be processed and temporarily stored in queue bundles 432 and 434) prior to processing of the selected packets by cores 412₁ and 412₂, and may redistribute the selected packets to queue 426 to be processed by core 412_{N}. (Note that the configuration of queues 422, 424, 426, is merely illustrative and other configurations are contemplated.) Redistribution of the packets can permit deactivation of queue bundles 432 and 434 and deactivation or power reduction of corresponding cores 412₁ and 412₂ by removing any remaining packets that await processing in queue bundles 432 and 434.

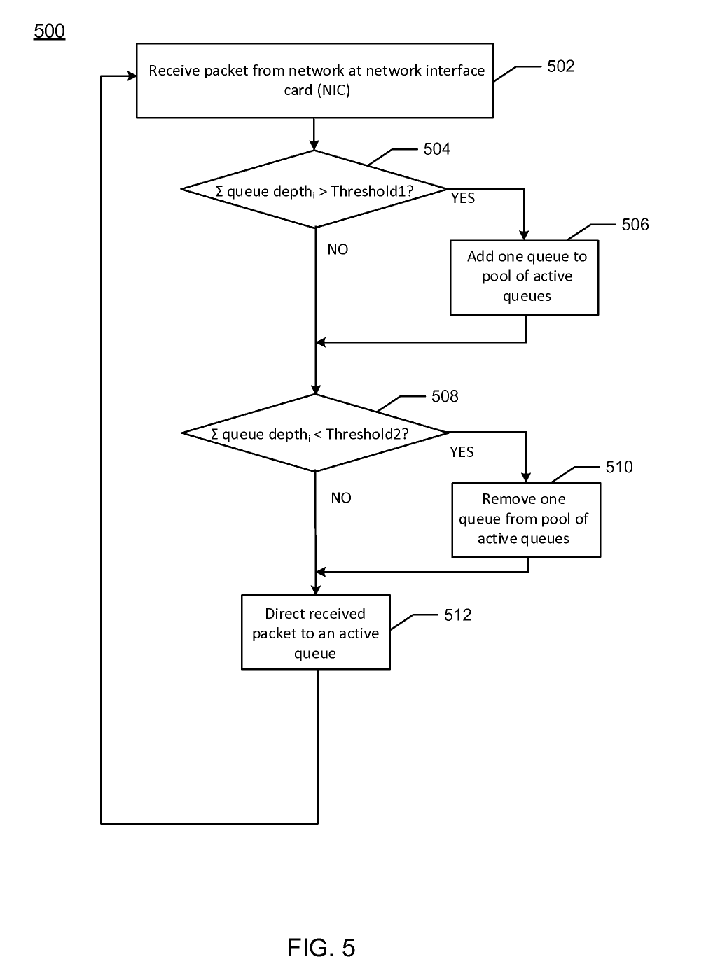

FIG. 5 is a flow diagram of a method, according to an embodiment of the present invention. Method 500 begins at block 502, where a packet is received from a network at a network interface card (NIC) that is interfaced to a processor, e.g., a multi-core processor. Continuing to decision diamond 504, if a sum of queue depths exceeds Threshold 1 (e.g., a high threshold), advancing to block 506 packet distribution logic (which may be situated in the NIC or in the processor) may add one queue to a pool of active queues (activate the queue). A corresponding core may be activated to process packets received by the activated queue. Moving to decision diamond 508, if the sum of queue depths is less than Threshold 2 (e.g., low threshold), moving to block 512 the packet distribution logic is to deactivate one queue, e.g., remove a selected queue from the pool of active queues. A corresponding core may be deactivated. Proceeding to block 512, the received packet may be directed to a queue chosen from among the active queues. In one embodiment, the queue chosen to store the received packet is the least populated active queue.

The method returns to block 502 and a subsequent packet is to be received by the NIC.

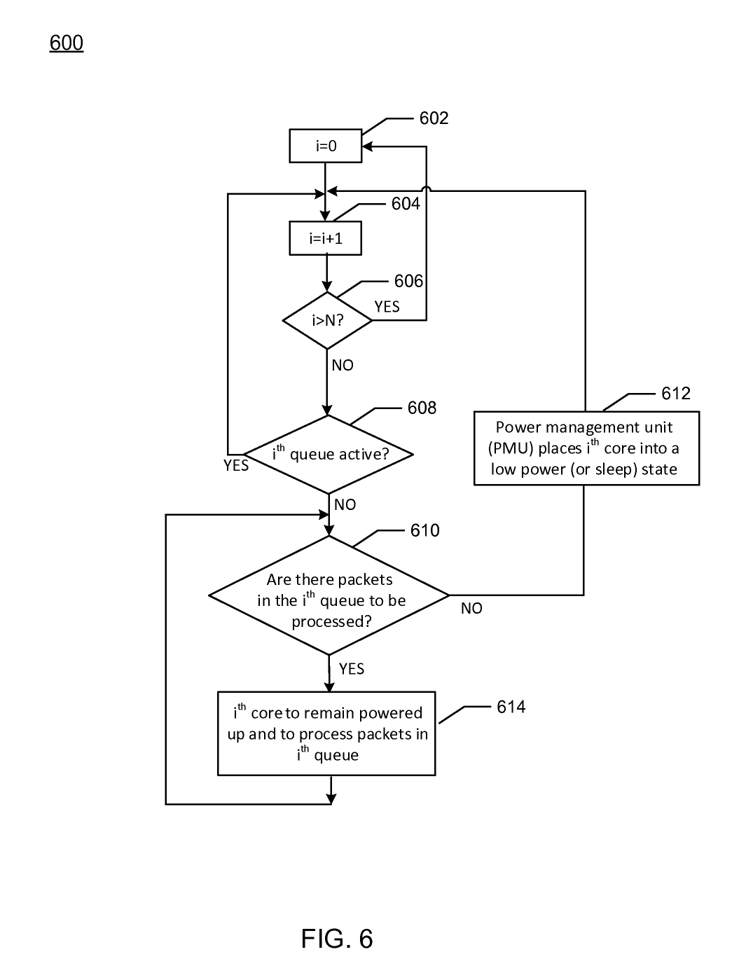

FIG. 6 is a method according to another embodiment of the present invention. Method 600 is a method of monitoring, by a power management unit (PMU) of a multi-core processor, each queue of the multi-core processor to determine which queues of the processor have been deactivated by, e.g., packet distribution logic that may be located a network interface card (NIC) that interfaces with the processor (or may be located in the processor), and to power down (or operate at a reduced power level) each core whose corresponding queue is deactivated and empty.

Queues may be labeled by an index i=1, N. Each queue, is to store and feed packets to a corresponding core for execution by the corresponding core.

At block 602, index i is set equal to zero (0). Continuing to block 604, the index i is incremented by one (1). Advancing to decision diamond 606, if the index i is greater than N, where N is a total number of queues in the processor, the method returns to block 602, and consideration of each queue begins again. If i is less than N, proceeding to decision diamond 608, if the i^{th} queue is active, returning to block 604 the index i is incremented, e.g., a sequentially next queue is considered. If, at decision diamond 608, the i^{th} queue is inactive (e.g., deactivated), proceeding to decision diamond 610 if there are packets in the (inactive) i^{th} queue that are waiting to be processed, continuing to block 614 a power management unit of the processor permits the i^{th} core to remain powered up to process packets in the i^{th} queue. Returning to decision diamond 610, when all packets stored in the i^{th} queue have been processed (e.g., the i^{th} queue is empty), advancing to block 612 the PMU places the i^{th} core into a low power or sleep state.

Thus, the PMU can detect that an activity level of a core has ceased due to the deactivation of corresponding queue by packet distribution logic (e.g., located in the NIC or in the processor), and the PMU can place the core into a low power state (e.g., a reduced power/performance state or a sleep state), after packets stored in the corresponding deactivated queue have been processed.

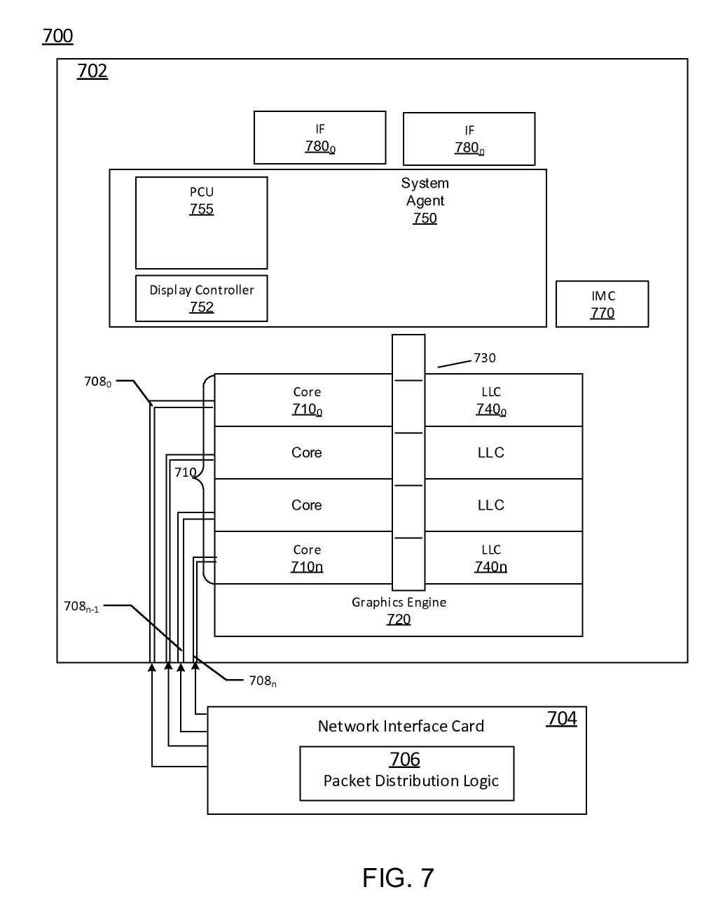

Referring now to FIG. 7, shown is a block diagram of a system 700 that includes a multi-domain processor 702 and a network interface card 704, in accordance with another embodiment of the present invention. As shown in the embodiment of FIG. 7, processor 702 includes multiple domains. Specifically, a core domain 710 can include a plurality of cores 710₀-710ₙ, and each core can be supplied with packets via a corresponding queue 708₀-708ₙ. The processor 702 also includes a graphics domain 720 that can include one or more graphics engines, and a system agent domain 750 may further be present. In some embodiments, system agent domain 750 may execute at an independent frequency than the core domain and may remain powered on at all times to handle power control events and power management such that domains 710 and 720 can be controlled to dynamically enter into and exit high power and low power states. Each of domains 710 and 720 may operate at different voltage and/or power. Note that while only shown with three domains, understand the scope of the present invention is not limited in this regard and additional domains can be present in other embodiments. For example, multiple core domains may be present each including at least one core.

In general, each core 710 may further include low level caches in addition to various execution units and additional processing elements. In turn, the various cores may be coupled to each other and to a shared cache memory formed of a plurality of units of a last level cache (LLC) 740₀-740ₙ. In various embodiments, LLC 740 may be shared amongst the cores and the graphics engine, as well as various media processing circuitry. As seen, a ring interconnect 730 thus couples the cores together, and provides interconnection between the cores, graphics domain 720 and system agent circuitry 750. In one embodiment, interconnect 730 can be part of the core domain. However in other embodiments the ring interconnect can be of its own domain.

As further seen, system agent domain 750 may include display controller 752 which may provide control of and an interface to an associated display. As further seen, system agent domain 750 may include a power control unit 755 to determine a corresponding power level at which to operate each core, according to embodiments described herein.

The processor 702 is coupled to the network interface card 704 that is to include packet distribution logic 706 that may determine which of the queues 708₀-708ₙ is to receive an incoming packet received from a network, and may determine whether to increase or decrease a count of active queues, according to embodiments of the present invention. For example, the packet distribution logic 706 may determine to activate a previously inactive queue, or to deactivate a currently active queue based on a comparison of a total queue depth to a first (e.g., high) threshold or comparison to a second (e.g., low) threshold. If a particular queue is deactivated, the PCU 755 may reduce power consumed by the corresponding core by placing the corresponding core into a low power state, e.g., a sleep state or a low power/performance state after remaining packets in the particular queue have been processed, according to embodiments of the present invention.

As further seen in FIG. 7, processor 700 can further include an integrated memory controller (IMC) 770 that can provide for an interface to a system memory, such as a dynamic random access memory (DRAM). Multiple interfaces 780₀-780ₙ may be present to enable interconnection between the processor and other circuitry. For example, in one embodiment at least one direct media interface (DMI) interface may be provided as well as one or more PCIe™ interfaces. Still further, to provide for communications between other agents such as additional processors or other circuitry, one or more QPI interfaces may also be provided. Although shown at this high level in the embodiment of FIG. 7, understand the scope of the present invention is not limited in this regard.

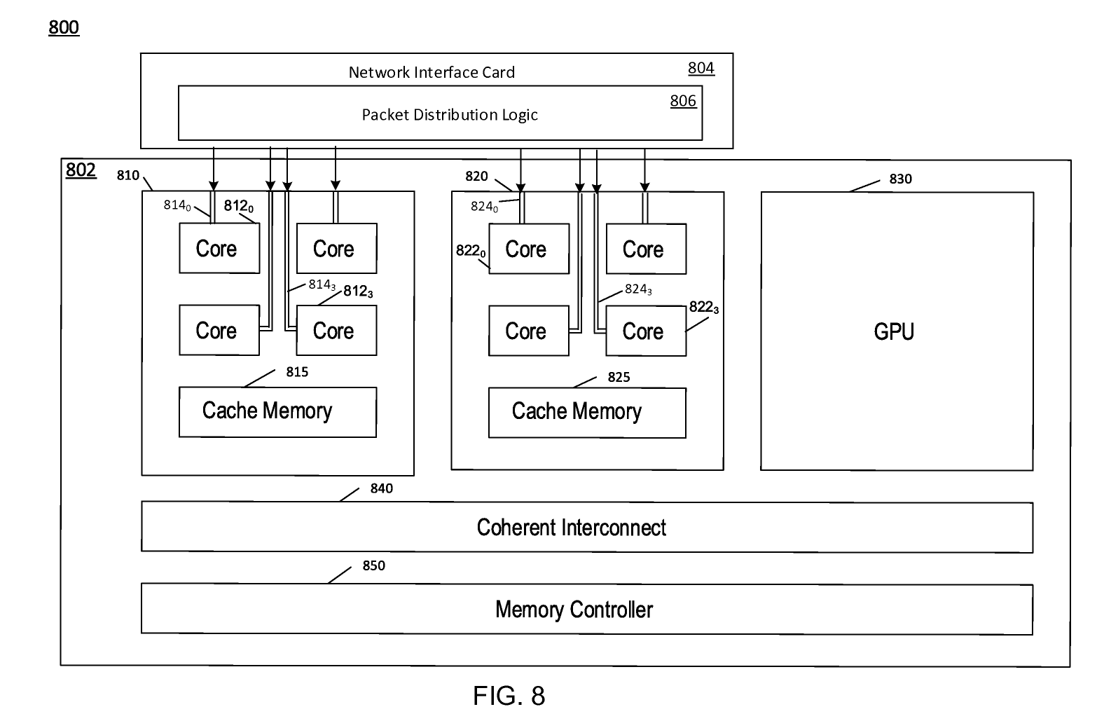

Referring now to FIG. 8, shown is a block diagram of a system 800 that includes a representative system on a chip (SoC) 802 coupled to a network interface card (NIC) 804. In the embodiment shown, SoC 800 may be a multi-core SoC configured for low power operation to be optimized for incorporation into a smartphone or other low power device such as a tablet computer or other portable computing device. As an example, SoC 800 may be implemented using asymmetric or different types of cores, such as combinations of higher power and/or low power cores, e.g., out-of-order cores and in-order cores. In different embodiments, these cores may be based on an Intel® Architecture™ core design or an ARM architecture design. In yet other embodiments, a mix of Intel and ARM cores may be implemented in a given SoC.

As seen in FIG. 8, SoC 800 includes a first core domain 810 having a plurality of first cores 812₀-812₃ each of which is to receive packets via a corresponding queue 814₀-814₃. In an example, cores 812₀-812₃ may be low power cores, such as in-order cores. In one embodiment the first cores 812₀-812₃ may be implemented as ARM Cortex A53 cores. In turn, these cores 812₀-812₃ couple to a cache memory 815 of core domain 810. In addition, SoC 802 includes a second core domain 820. In the illustration of FIG. 8, second core domain 820 has a plurality of second cores 822₀-822₃ each of which is to receive packets via a corresponding queue 824₀-824₃. In an example, these cores 822₀-822₃ may be higher power-consuming cores than first cores 812. In an embodiment, the second cores 822₀-822₃ may be out-of-order cores, which may be implemented as ARM Cortex A57 cores. In turn, these cores 822₀-822₃ couple to a cache memory 825 of core domain 820. Note that while the example shown in FIG. 8 includes 4 cores in each domain, understand that more or fewer cores may be present in a given domain in other examples.

Each of the queues 814₀-814₃ and 824₀-824₃ may be coupled to the NIC 804, which includes packet distribution logic 806 that may determine which of queues 814₀-814₃ and 824₀-824₃ is to receive an incoming packet received from a network. Packet distribution logic 806 may also determine whether to increase or decrease a count of active queues, according to embodiments of the present invention. For example, the packet distribution logic 806 may determine to activate an inactive queue, or to deactivate a currently active queue, based on a comparison of a total queue depth to a first (e.g., high) threshold or comparison to a second (e.g., low) threshold. If a particular queue is to be deactivated, power consumed by the corresponding core may be reduced, e.g., the core may be placed into a sleep state or into a reduced power/performance state by, e.g., a power management unit of the SoC 802 (not shown).

With further reference to FIG. 8, a graphics domain 830 also is provided, which may include one or more graphics processing units (GPUs) configured to independently execute graphics workloads, e.g., provided by one or more cores of core domains 810 and 820. As an example, GPU domain 830 may be used to provide display support for a variety of screen sizes, in addition to providing graphics and display rendering operations.

As seen, the various domains couple to a coherent interconnect 840, which in an embodiment may be a cache coherent interconnect fabric that in turn couples to an integrated memory controller 850. Coherent interconnect 840 may include a shared cache memory, such as an L3 cache, in some examples. In an embodiment, memory controller 850 may be a direct memory controller to provide for multiple channels of communication with an off-chip memory, such as multiple channels of a DRAM (not shown for ease of illustration in FIG. 8).

In different examples, the number of the core domains may vary. For example, for a low power SoC suitable for incorporation into a mobile computing device, a limited number of core domains such as shown in FIG. 8 may be present. Still further, in such low power SoCs, core domain 820 including higher power cores may have fewer numbers of such cores. For example, in one implementation two cores 822 may be provided to enable operation at reduced power consumption levels. In addition, the different core domains may also be coupled to an interrupt controller to enable dynamic swapping of workloads between the different domains.

In yet other embodiments, a greater number of core domains, as well as additional optional IP logic may be present, in that an SoC can be scaled to higher performance (and power) levels for incorporation into other computing devices, such as desktops, servers, high performance computing systems, base stations forth. As one such example, 4 core domains each having a given number of out-of-order cores may be provided. Still further, in addition to optional GPU support (which as an example may take the form of a GPGPU), one or more accelerators to provide optimized hardware support for particular functions (e.g. web serving, network processing, switching or so forth) also may be provided. In addition, an input/output interface may be present to couple such accelerators to off-chip components.

Additional embodiments are described below.

In a 1^{st} embodiment, a system includes a processor that includes a plurality of cores and a plurality of queues, where each queue includes storage locations to store packets to be processed by at least one of the cores, each queue has a corresponding state that is one of active and inactive, each active queue is enabled to store an incoming packet, and each inactive queue is disabled from storage of the incoming packet, and where each queue has a corresponding queue depth comprising a count of occupied storage locations of the queue. The system also includes packet distribution logic to determine whether to change the state of a first queue of the plurality of queues from a first state to a second state based on a total queue depth comprising a sum of the queue depths of the active queues.

A 2^{nd} embodiment includes elements of the 1^{st} embodiment, where when the total queue depth exceeds a first threshold the packet distribution logic is to change the state of the first queue from the first state of inactive to the second state of active.

A 3^{rd} embodiment includes elements of the 2^{nd} embodiment, where after the state of the first queue has been changed to active, the packet distribution logic is to direct the incoming packet to be stored in the first queue.

A 4^{th} embodiment includes elements of the 2^{nd} embodiment, where the processor further includes a power management unit (PMU), and where responsive to activation of the first queue, the PMU is to change a corresponding core from a reduced power state into an active power state that consumes more power than the reduced power state.

A 5th embodiment includes elements of the 1^{st} embodiment, where when the total queue depth is less than a second threshold the packet distribution logic is to change the state of a second queue from the first state of active to the second state of inactive.

A 6^{th} embodiment includes elements of the 5^{th} embodiment, where the queue depth of the second queue is least of the queue depths of the active queues.

A 7^{th} embodiment includes elements of the 5^{th} embodiment, where the processor further comprises a power management unit (PMU), and responsive to deactivation of the second queue, the PMU is to change a core state of a corresponding core from an active state to a reduced power state.

An 8^{th} embodiment includes elements of the 5^{th} embodiment, where the packet distribution logic is to, responsive to deactivation of the second queue, cause the corresponding core to change from an active state to a reduced power state.

A 9^{th} embodiment includes elements of any one of embodiments 1 to 8, where the packet distribution logic is to direct an incoming packet to be stored in a third queue whose corresponding state is active, where the queue depth of the third queue is least of the queue depths of the active queues.

A 10^{th} embodiment includes elements of any one of embodiments 1 to 8, further including a network interface card (NIC) that is coupled to the processor and that includes the packet distribution logic, where the NIC is to receive incoming packets from a network and the packet distribution logic is to select, for each incoming packet, a corresponding active queue to store the incoming packet.

An 11^{th} embodiment includes at least one machine-readable storage medium including instructions that when executed enable a system to determine a total queue depth of active queues of a processor that comprises a plurality of cores and a plurality of queues, where each core has at least one corresponding queue to store packets to be processed by the core, where each queue has a corresponding state that is one of active and inactive, where each active queue is enabled to receive and store an incoming packet received from a network interface card (NIC) coupled to the processor and each inactive queue is disabled from receipt and storage of the incoming packet, each active queue has an associated queue depth comprising a count of occupied locations in the queue, and where the total queue depth includes a sum of the queue depths of the active queues; and to determine, based at least on the total queue depth, whether to change the state of a first queue of the plurality of queues.

A 12^{th} embodiment includes elements of the 11^{th} embodiment, and further includes instructions to change the state of the first queue from inactive to active responsive to the total queue depth exceeding a first threshold.

A 13^{th} embodiment includes elements of the 12^{th} embodiment, and further includes instructions to direct the incoming packet to the first queue for storage after the state of the first queue has been changed to active.

A 14^{th} embodiment includes elements of the 12^{th} embodiment, further includes instructions to, responsive to activation of the first queue, place a corresponding core from a low power state into an active power state that is to consume more power than the low power state.

A 15^{th} embodiment includes elements of the any one of embodiments 11 to 14, and further includes instructions to change the state of the first queue from active to inactive responsive to the total queue depth being less than a second threshold.

A 16^{th} embodiment includes elements of the 15^{th} embodiment, where the second threshold is to be determined based on a rate of change of the total queue depth over time.

A 17^{th} embodiment includes elements of the 15^{th} embodiment, and further includes instructions to, responsive to deactivation of the first queue, cause a corresponding core to change from an active power state to a reduced power state that consumes less power than the active power state.

An 18^{th} embodiment is a method that includes determining, for each of a plurality of active queues, a corresponding queue depth comprising a count of occupied storage locations of a processor that includes a plurality of cores and a plurality of queues, wherein each queue is associated with at least one of the cores and each queue has a corresponding state that is one of active and inactive, wherein each active queue is enabled to store an incoming packet received from a network interface card (NIC) coupled to the processor, each inactive queue is disabled from receipt and storage of the incoming packet, and each core is to process one or more packets to be received from at least one of the active queues. The method also includes directing the incoming packet from the NIC to a first active queue selected from the active queues based on the corresponding queue depth.

A 19^{th} embodiment includes elements of the 18^{th} embodiment, and further includes directing the incoming packet to the first active queue responsive to the corresponding queue depth being a least of the respective queue depths of the active queues.

A 20^{th} embodiment includes elements of the 18^{th} embodiment, and further includes determining, based at least on a total queue depth, whether to change the corresponding state of a second queue of the plurality of queues, wherein the total queue depth comprises sum of queue depths of the active queues.

A 21^{st} embodiment includes elements of the 20^{th} embodiment, and further includes changing the corresponding state of the second queue from inactive to active responsive to the total queue depth exceeding a first threshold.

A 22^{nd} embodiment includes elements of the 21^{st} embodiment, and further includes directing the incoming packet to the second queue for storage after the corresponding state of the second queue has been changed to active.

A 23^{rd} embodiment includes elements of the 21^{st} and further includes responsive to activation of the second queue, causing a corresponding core to change from a low power state into an active power state that is to consume more power than the low power state.

A 24^{th} embodiment includes elements of the 20^{th} embodiment, and further includes changing the corresponding state of the second queue from active to inactive responsive to the total queue depth being less than a second threshold.

A 25^{th} embodiment includes elements of the 24^{th} embodiment, where the second threshold is to be determined based on a rate of change of the total queue depth over time.

A 26^{th} embodiment includes elements of the 24^{th} embodiment, and further includes responsive to the corresponding state of the second queue changing to inactive, causing a corresponding core to change from an active power state to a reduced power state that consumes less power than the active power state.

A 27^{th} embodiment is an apparatus that includes means for performing the method of any one of embodiments 18-26.

A 28^{th} embodiment is an apparatus to perform the method of any one of embodiments 18-26.

A 29^{th} embodiment is a method that includes determining a total queue depth of active queues of a processor that comprises a plurality of cores and a plurality of queues, where each core has at least one corresponding queue to store packets to be processed by the core, where the total queue depth comprises a count of occupied locations of all active queues of the plurality of queues, where each queue of the active queues has a corresponding queue depth comprising a count of occupied locations of the active queue and each queue has a corresponding state that is one of active and inactive, where each active queue is enabled to receive and store an incoming packet from a network interface card (NIC) coupled to the processor, and each inactive queue is disabled from receipt and storage of the incoming packet. The method further includes determining, based at least on the total queue depth, whether to change the corresponding state of a first queue of the plurality of queues.

A 30^{th} embodiment includes elements of the 29^{th} embodiment, and further includes changing the corresponding state of the first queue from inactive to active responsive to the total queue depth being greater than a first threshold.

A 31^{st} embodiment includes elements of the 29^{th} embodiment, and further includes changing the corresponding state of the first queue from active to inactive responsive to the total queue depth being less than a second threshold.

A 32^{nd} embodiment includes elements of the 31^{st} embodiment, and further includes responsive to the corresponding state of the first queue changing to inactive, causing a corresponding core to change from an active power state to a reduced power state that consumes less power than the active power state.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system comprising:
a processor comprising a plurality of cores and a plurality of queues, wherein each queue includes storage locations to store packets to be processed by at least one of the cores, each queue has a corresponding state that is one of active and inactive, each active queue is enabled to store an incoming packet, and each inactive queue is disabled from storage of the incoming packet, and wherein each queue has a corresponding queue depth comprising a count of occupied storage locations of the queue; and
packet distribution logic to determine whether to change the state of a first queue of the plurality of queues from a first state to a second state based on a total queue depth comprising a sum of the queue depths of the active queues.

2. The system of claim 1, wherein when the total queue depth exceeds a first threshold the packet distribution logic is to change the state of the first queue from the first state of inactive to the second state of active.

3. The system of claim 2, wherein after the state of the first queue has been changed to active, the packet distribution logic is to direct the incoming packet to be stored in the first queue.

4. The system of claim 2, wherein the processor further comprises a power management unit (PMU), and wherein responsive to activation of the first queue, the PMU is to change a corresponding core from a reduced power state into an active power state that consumes more power than the reduced power state.

5. The system of claim 1, wherein when the total queue depth is less than a second threshold the packet distribution logic is to change the state of a second queue from the first state of active to the second state of inactive.

6. The system of claim 5, wherein the queue depth of the second queue is least of the queue depths of the active queues.

7. The system of claim 5, wherein the processor further comprises a power management unit (PMU), and responsive to deactivation of the second queue, the PMU is to change a core state of a corresponding core from an active state to a reduced power state.

8. The system of claim 5, wherein the packet distribution logic is to, responsive to deactivation of the second queue, cause the corresponding core to change from an active state to a reduced power state.

9. The system of claim 1, wherein the packet distribution logic is to direct an incoming packet to be stored in a third queue whose corresponding state is active, wherein the queue depth of the third queue is least of the queue depths of the active queues.

10. The system of claim 1, further comprising a network interface card (NIC) that is coupled to the processor and that includes the packet distribution logic, wherein the NIC is to receive incoming packets from a network and the packet distribution logic is to select, for each incoming packet, a corresponding active queue to store the incoming packet.

11. At least one machine-readable storage medium including instructions that when executed enable a system to:
determine a total queue depth of active queues of a processor that comprises a plurality of cores and a plurality of queues, wherein each core has at least one corresponding queue to store packets to be processed by the core, wherein each queue has a corresponding state that is one of active and inactive, wherein each active queue is enabled to receive and store an incoming packet received from a network interface card (NIC) coupled to the processor and each inactive queue is disabled from receipt and storage of the incoming packet, each active queue has an associated queue depth comprising a count of occupied locations in the queue, and wherein the total queue depth comprises a sum of the queue depths of the active queues; and
determine, based at least on the total queue depth, whether to change the state of a first queue of the plurality of queues.

12. The at least one machine-readable storage medium of claim 11, further including instructions to change the state of the first queue from inactive to active responsive to the total queue depth exceeding a first threshold.

13. The at least one machine-readable storage medium of claim 12, further including instructions to direct the incoming packet to the first queue for storage after the state of the first queue has been changed to active.

14. The at least one machine-readable storage medium of claim 12, further including instructions to, responsive to activation of the first queue, place a corresponding core from a low power state into an active power state that is to consume more power than the low power state.

15. The at least one machine-readable storage medium of claim 11, further including instructions to change the state of the first queue from active to inactive responsive to the total queue depth being less than a second threshold.

16. The at least one machine-readable storage medium of claim 15, wherein the second threshold is to be determined based on a rate of change of the total queue depth over time.

17. The at least one machine-readable storage medium of claim 15, further including instructions to, responsive to deactivation of the first queue, cause a corresponding core to change from an active power state to a reduced power state that consumes less power than the active power state.

18. A method comprising:
determining, for each of a plurality of active queues, a corresponding queue depth comprising a count of occupied storage locations of a processor that includes a plurality of cores and a plurality of queues, wherein each queue is associated with at least one of the cores and each queue has a corresponding state that is one of active and inactive, wherein each active queue is enabled to store an incoming packet received from a network interface card (NIC) coupled to the processor, each inactive queue is disabled from receipt and storage of the incoming packet, and each core is to process one or more packets to be received from at least one of the active queues; and
directing the incoming packet from the NIC to a first active queue selected from the active queues based on the corresponding queue depth.

19. The method of claim 18, further comprising directing the incoming packet to the first active queue responsive to the corresponding queue depth being a least of the respective queue depths of the active queues.

20. The method of claim 18, further comprising determining, based at least on a total queue depth, whether to change the state of a second queue of the plurality of queues, wherein the total queue depth comprises sum of queue depths of the active queues.
